(19) United States
(12) Patent Application Publication
(10) Pub. No.: US 2017/0241277 A1
(43) Pub. Date: Aug. 24, 2017

(54) MOVABLE INTERFACE FOR GAS TURBINE ENGINE

(71) Applicant: Siemens Energy, Inc., Orlando, FL (US)

(72) Inventors: Andrew Carlson, Jupiter, FL (US); Richard C. Charron, West Palm Beach, FL (US)

(21) Appl. No.: 15/050,604

(22) Filed: Feb. 23, 2016

(51) Int. Cl. F01D 9/02; H02K 7/18

(52) U.S. Cl. CPC F01D 9/023; H02K 7/1823; F23R 3/46

(57) ABSTRACT

A gas turbine engine has a movable interface that permits rotation of the inlet portion and cone. The movable interface moves within a surface of the flow sleeve that is designed to receive the movable interface. A sealing ring and groove located at the connection between the sealing ring and groove allow axial movement.

### STATEMENT REGARDING FEDERALLY SPONSORED DEVELOPMENT

This invention was made with government support under Program DE-FE0023955, awarded by the United States Department of Energy. The government has certain rights in the invention.

### BACKGROUND

1. Field

Disclosed embodiments are generally related to gas turbine engines and, more particularly to the transition system used in gas turbine engines.

2. Description of the Related Art

A gas turbine engine typically has a compressor section, a combustion section having a number of combustors and a turbine section. Ambient air is compressed in the compressor section and conveyed to the combustors in the combustion section. The combustors combine the compressed air with a fuel and ignite the mixture creating combustion products. The combustion products flow in a turbulent manner and at a high velocity. The combustion products are routed to the turbine section via transition ducts. Within the turbine section are rows of vane assemblies. Rotating blade assemblies are coupled to a turbine rotor. As the combustion product expands through the turbine section, the combustion product causes the blade assemblies and turbine rotor to rotate. The turbine rotor may be linked to an electric generator and used to generate electricity.

During the operation of gas turbine engines strong forces are generated that can impact the structure of the gas turbine engine. These forces may occur in the transition duct. Accommodating these forces to avoid breakage is important for the continued operation of the gas turbine engine.

### SUMMARY

Briefly described, aspects of the present disclosure relate to the interaction between the inlet portion, cone and IEP in gas turbine engines.

An aspect of the disclosure may be a gas turbine engine comprising an inlet portion located at a combustor exit. The gas turbine engine further has a cone connected to the inlet portion, wherein working gases from upstream flow downstream through the combustor exit and inlet portion to the cone. Additionally an integrated exit piece is connected to the cone, wherein working gases from the cone flow through the integrated exit piece; an inlet ring forms a perimeter of the inlet portion surrounding the combustor exit, wherein the inlet ring has a plurality of struts extending radially. There is also a movable interface having a movable interface inner surface and a movable interface outer surface, wherein the movable interface surrounds the inlet ring and is connected to the plurality of struts, wherein the movable interface outer surface is curved. The movable interface further has a flow sleeve surrounding the inlet ring having a sleeve inner surface and a sleeve outer surface; wherein the sleeve inner surface is curved and movably engages the movable interface outer surface.

Another aspect of the present disclosure may be a structure for rigidly connecting a cone to a combustor exit allowing movement between a flow sleeve and a cone in a gas turbine engine having an inlet ring forming a perimeter of an inlet portion surrounding the combustor exit, wherein the inlet ring has a plurality of struts extending radially, a movable interface having a movable interface inner surface and a movable interface outer surface, wherein the movable interface surrounds the inlet ring and is connected to the plurality of struts, wherein the movable interface outer surface is curved; and a flow sleeve surrounding the inlet ring having a sleeve inner surface and a sleeve outer surface; wherein the sleeve inner surface is curved and movably engages the movable interface outer surface allowing the cone to slide for angular alignment.

Still another aspect of the present disclosure may be a gas turbine engine comprising an inlet portion located at a combustor exit, a cone connected to the inlet portion, wherein working gases from upstream flow downstream through the inlet portion and combustor exit to the cone and an integrated exit piece connected to the cone, wherein working gases from the cone flow through the integrated exit piece. The gas turbine engine may also have an inlet ring forming a perimeter of the inlet portion surrounding the combustor exit, wherein the inlet ring has a plurality of struts extending radially, a movable interface having a movable interface inner surface and a movable interface outer surface, wherein the movable interface surrounds the inlet ring and is connected to the plurality of struts and wherein the movable interface outer surface is spherically curved. The gas turbine engine may also have a flow sleeve surrounding the inlet ring having a sleeve inner surface and a sleeve outer surface, wherein the sleeve inner surface is spherically curved and corresponds in size and shape to the movable interface outer surface, and wherein the sleeve inner surface movably engages the movable interface outer surface to correct misalignment of the cone.

### BRIEF DESCRIPTION OF THE DRAWINGS

FIG. 1 shows a cross sectional view through a portion of a gas turbine engine.

FIG. 2 is a sectional view of the inlet portion, cone and IEP.

FIG. 3 is a close up view of the connection between the inlet portion and the flow sleeve.

FIG. 4 is a close up view of the connection between the cone and the inlet portion.

FIG. 5 is a close up view of the connection between the cone and the IEP.

FIG. 6 is shows an alternative embodiment having a sealing ring located at the interface between the IEP and the cone.

FIG. 7 is a diagrammatic view illustrating the rotation of the inlet portion.

FIG. 8 is diagrammatic view illustrating the range for correcting misalignment.

### DETAILED DESCRIPTION

To facilitate an understanding of embodiments, principles, and features of the present disclosure, they are explained hereinafter with reference to implementation in illustrative embodiments. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

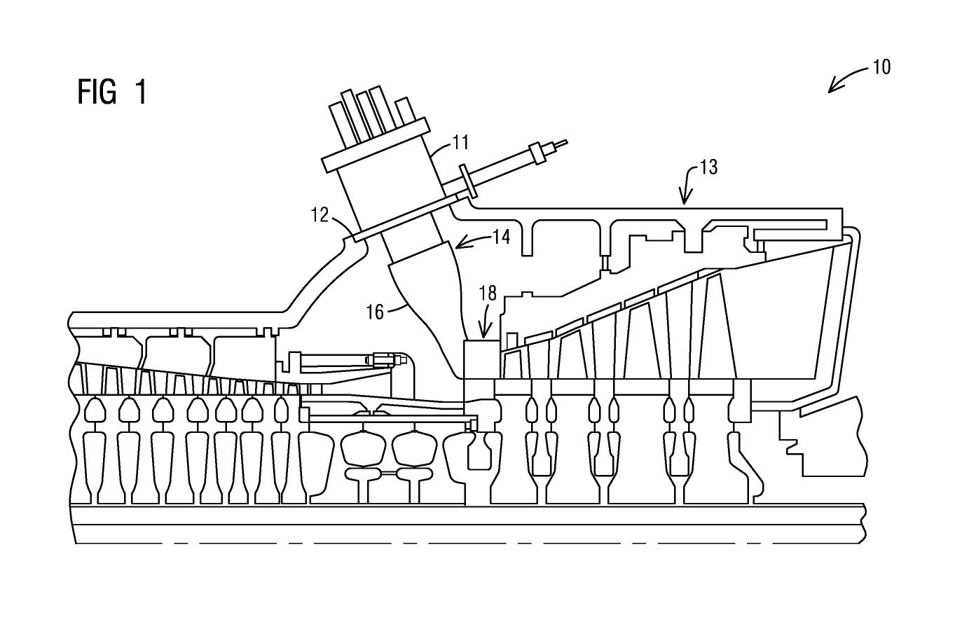

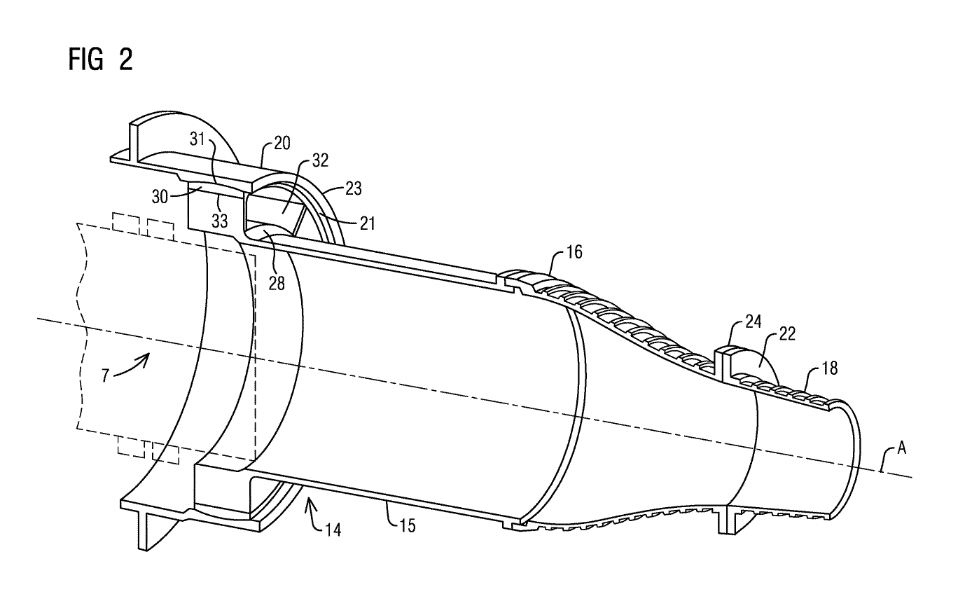

FIG. 1 shows a cross sectional view through a portion of a gas turbine engine 10. The cross sectional view shows a compressor section 9, a combustion section 11 and a turbine section 13. The compressor section 11 compresses ambient air and supplies the compressed air to combustors 12 located in the combustion section 11. The combustors 12 combine the compressed air with fuel and ignite the mixture to create combustion products forming a hot working gas flow from each of the combustors 12. The hot working gas flows from the combustors 12 to and through a plurality of inlet portions 14, cones 16 and integrated exit pieces (IEPs) 18. Inlet portion 14 may comprise an inlet extension 15, as shown in FIG. 2. The IEPs 18 are connected to form an annular structure that delivers the flow to the turbine section 13. As used herein “upstream” and “downstream” are used to refer to the flow of air and fuel through the gas turbine engine 10, where gas flows from upstream to downstream through the gas turbine engine.

FIG. 2 is a close up cut away view of one set of the combustor exit 14, inlet extension 15, cones 16 and IEPs 18. Running through the center of the combustor exit 7, inlet portion 14, inlet extension 15, cone 16 and IEP 18 is an axis A. Inlet portion 14 surrounds the combustor exit 7. In a direction perpendicular to the axis A is the radial direction R. The circumferential direction C is along the circumference of the combustor exit 7, inlet portion 14, inlet extension 15, cone 16 and IEP 18.

The gas flow travels from upstream through the combustor 12, shown in FIG. 1, into the combustor exit 7. From the combustor exit 7 the gas flow travels through the inlet portion 14, inlet extension 15, cone 16 into the IEP 18. Preferably the cone 16 is positioned concentrically with the combustor exit 7 to limit problems that can occur with the combustor 12 due to misalignment. During operation of the gas turbine engine 10, misalignment can occur resulting from thermal displacements and tolerances between the inlet extension 15 and the cone 16. Also, in some gas turbine engines a number of hardware components are used to securely fasten the cone to the IEP. The tolerances and large thermal displacements of the parts can lead to large stresses to be focused on the IEP. Additionally, some gas turbine engines require “blind” assembly and maintenance. This means that access to the interior of the transition section is needed in order to assemble with hardware or perform maintenance on the gas turbine engine.

In FIG. 2 an embodiment of the present invention is shown which is able to achieve improved results related to misalignment, stress load and blind assembly. In the embodiment shown is a combustor exit 7 that is surrounded by the inlet portion 14 and flow sleeve 20. The combustor exit 7 permits the gas flow from the combustor 12 to travel downstream through the inlet portion 14 to the cone 16 and through the IEP 18. In the embodiment shown in FIG. 2 there is an inlet extension 15 that forms part of the inlet portion 14 and extends to the cone 16. It should be understood that some gas turbine engines may not have an inlet extension 15 and the inlet portion 14 located at the combustor exit 7 may be connected directly to the cone 16 with an inlet ring 28.

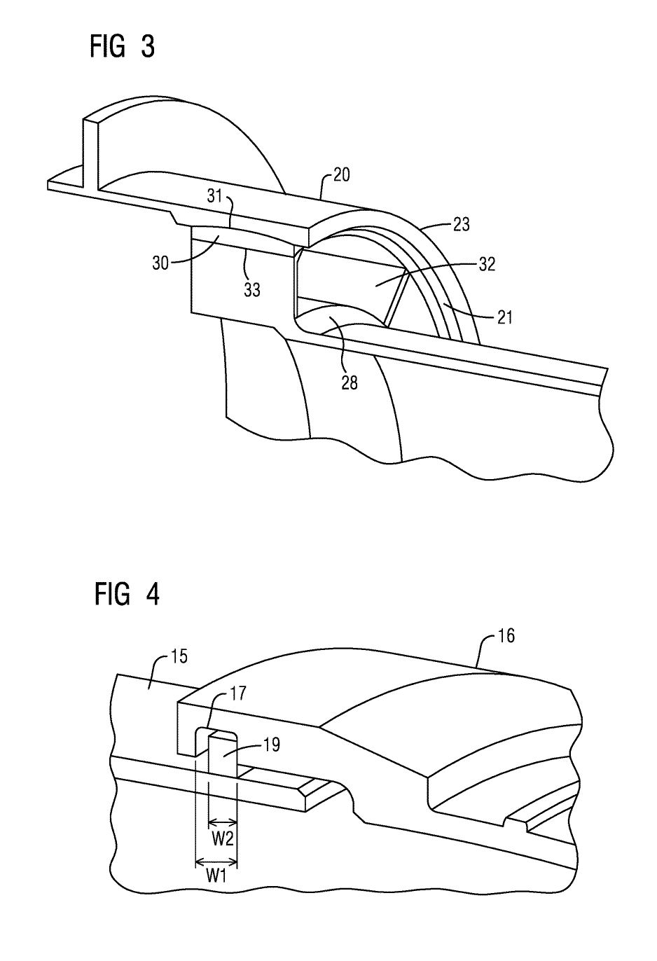

A longitudinal axis A extends through the center of the combustor exit 7, inlet portion 14, cone 16 and IEP 18. The inlet portion 14 is cylindrical in shape. As shown close up in FIG. 3, forming part of the inlet portion is an inlet ring 28. The inlet ring 28 forms a perimeter of the of the inlet portion 14 that surrounds the combustor exit 7 and circumferentially extends around the longitudinal axis A.

Extending radially from the inlet ring 28 is a plurality of struts 32. The struts 32 extend radially a distance sufficient to join with the movable interface 30. The struts 32 are integrally formed with the inlet ring 28 and are spaced equidistantly around the circumference of the inlet ring 28. While the struts 32 are spaced equidistantly around the circumference of the inlet ring 28, it should be understood that alternative spacing of the struts 32 may be used, such as irregular spacing. The movable interface 30 provides support for the loads that impact the struts 32 and the cone 16. Additionally the struts 32 permit air to flow through the space between the inlet ring 28 and the flow sleeve 20.

Movable interface 30 has a movable interface outer surface 31 and a movable interface inner surface 33. Movable interface 30 is integrally connected to the struts 32 along the movable interface inner surface 33. The movable interface 30 extends in a circumferential direction around the perimeter of the inlet ring 28. The movable interface outer surface 31 provides a surface that is adapted to slidably engage a portion of flow sleeve 20.

Flow sleeve 20 surrounds inlet ring 28 and further contains and seals inlet portion 14 and combustor exit 7. Flow sleeve 20 is located radially further away from the longitudinal axis A than the inlet ring 28. Flow sleeve 29 has a sleeve outer surface 23 and a sleeve inner surface 21. The sleeve inner surface 21 is shaped to engage the movable interface outer surface 31 in a manner which permits it to slidably engage and interact with it.

In the embodiment shown in FIGS. 2 and 3 the sleeve inner surface 21 is sized and shaped so that the movable interface outer surface 31 can permit rotation of the inlet portion 14 and cone 16 about a point located on the longitudinal axis A. The rotational movement is a swivel like movement about the point locating on the longitudinal axis A. In order to accomplish the rotation, preferably the movable interface outer surface 31 is curved. More preferably the movable outer surface 31 is spherically curved. By “spherically curved” it means that the movable outer surface 31 is curved so that if movable interface 30 was extended to form a complete sphere with the center of the sphere located at a point on longitudinal axis A, the curve would correspond to the surface of the sphere. The diameter of the sphere that would correspond to the curve may be between 10-50% greater than the diameter of the combustor exit 14. More preferably the diameter may be between 20-30% greater than the diameter of the combustor exit 14. Sleeve inner surface 21 is preferably curved so as to correspond in size and shape to the movable interface outer surface 31. This permits the sleeve inner surface 21 to function as a “socket” for the moveable interface outer surface 31. Sleeve inner surface 21 may be spherically curved when movable interface outer surface 31 is spherically curved. When both sleeve inner surface 21 and movable interface outer surface 31 are spherically curved the centers of the spheres formed by their curves are located at the same point along the longitudinal axis A. When sleeve inner surface 21 is curved in the same manner as movable interface outer surface 31 the movable interface 30 is able to move within the space formed by the sleeve inner surface 21. Interaction of the movable interface 30 with the flow sleeve 20 permits rotation of the inlet portion 14 within a range of 0.1° to 5° about a circle formed from the axial center of rotation. A 0.5 degree rotation will permit a re-alignment of ±11 mm of the cone 16 with the inlet extension 15. The rotation that occurs may be a sliding rotation. Movement in the axial direction is restricted by interaction of the sealing ring 19 with the slot 17 discussed below. The spherically curved surface of the movable interface 30 is also able to take axial loads caused by aerodynamics within the cone 16.

During assembly, the secure fit of the movable interface outer surface 31 within the sleeve inner surface 21 permits easy assembly by avoiding the use of hardware, brazing, welding or other ways of connecting the combustor exit 14 to the inlet extension 15 and the cone 16. Additionally, misalignment can be correct with having to access the interior of the transition section. Furthermore, the assembly shown in FIGS. 2 and 3 allows the stress load that occurs during combustion to be focused at the inlet ring 28 rather than at the IEP 18. The inlet ring 28 is able to handle a larger stress load than the IEP 18.

FIG. 4 shows the interface between the cone 16 and the inlet extension piece 15 of the inlet portion 14. Located upstream from the connection of the IEP 18 to the cone 16 at a distal end of the cone 16 is a slot 17 that is formed circumferentially around the perimeter of the cone 16. During assembly a sealing ring 19 is located within the slot 17. This forms the connection of the inlet portion 14 to the cone 16.

The slot 17 has a width W₁ and the sealing ring has a width W₂. Preferably the width W₂ of the sealing ring 19 is less than the width W₁ of the slot 17. This permits axial movement of the cone 16 and inlet extension piece 15 with respect to each other. This movement assists in adapting to the misalignment of the combustor exit 14 and the cone 16 and further assists with handling thermo-mechanical stresses that occur during the operation of the gas turbine engine 10. It should be understood that while the slot 17 and sealing ring 19 are used in this embodiment, it is possible that the cone 16 is securely engaged to the inlet extension piece 15 through the use of bolts, welding or other connection means.

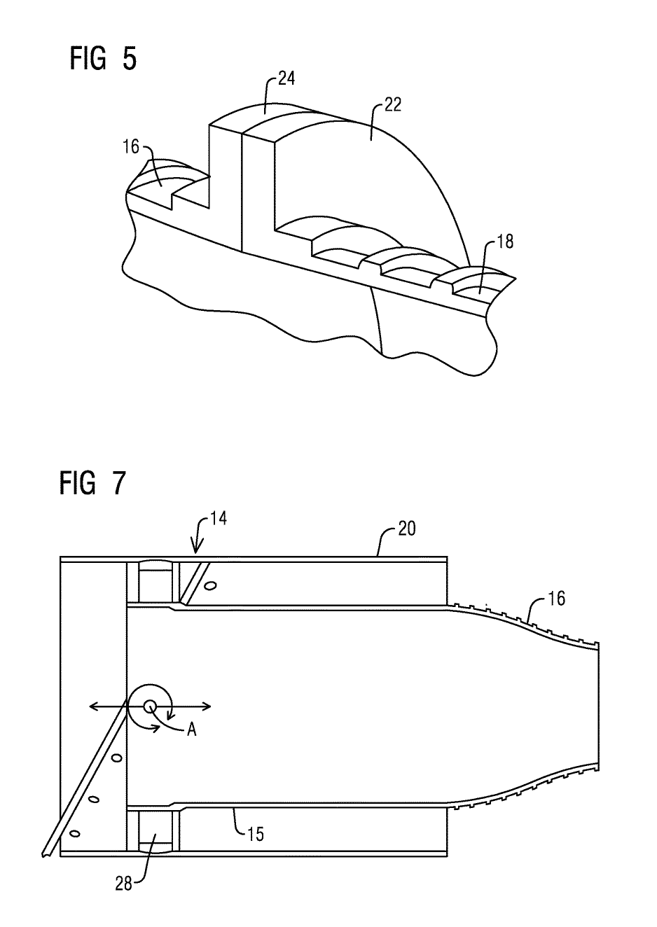

FIG. 5 shows the connection of cone 16 to the IEP 18. In the embodiment shown in FIG. 5, cone flange 24 is secured to IEP flange 22 by bolting, welding, brazing or other securing means.

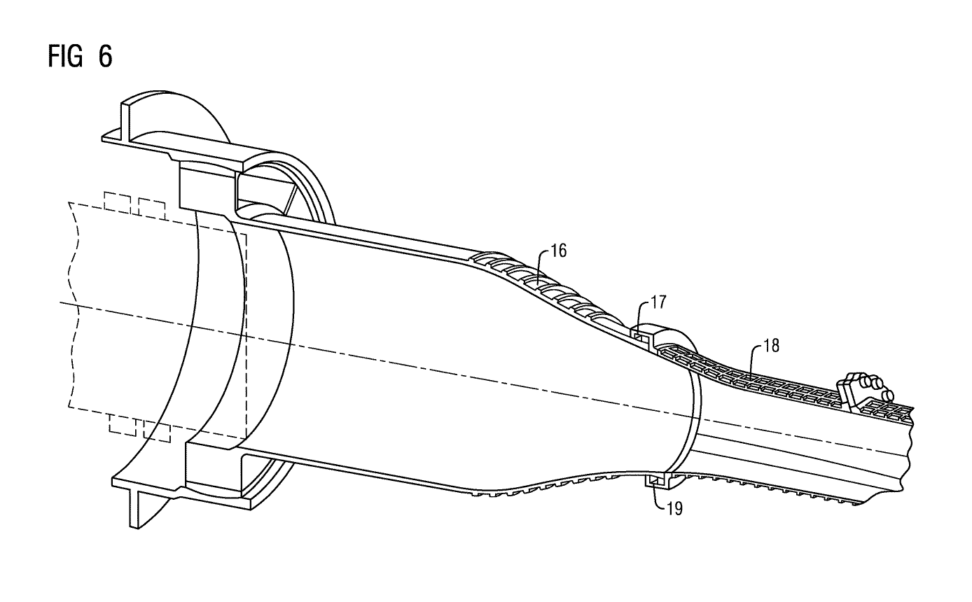

FIG. 6 shows an alternative embodiment of an interface between a cone 16 and an IEP 18 where a slot 17 and sealing ring 19 are located at this interface as opposed to the interface between the inlet extension piece 15 and cone 16 as shown in FIG. 4. Located at the downstream end of the cone 16 at the connection of the IEP 18 to the cone 16 is a slot 17 that is formed circumferentially around the perimeter of the IEP 18. During assembly a sealing ring 19 is located within the slot 17. The slot 17 and sealing ring 19 operate in a similar manner as the slot 17 and sealing 19 in FIG. 4.

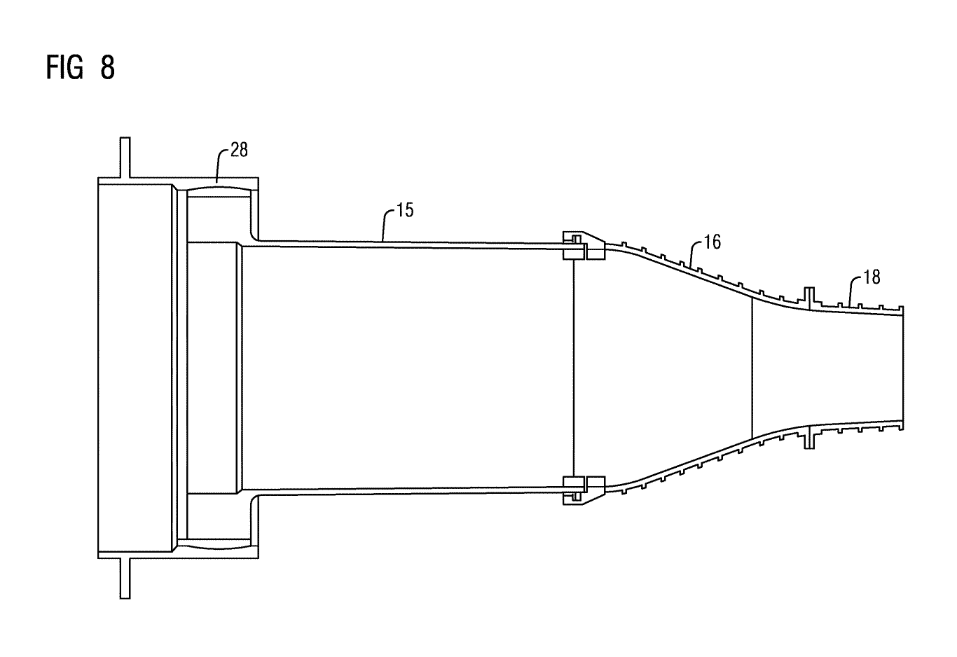

FIG. 7 is a diagrammatic view of the inlet ring 28, flow sleeve 20 and inlet portion 14 illustrating the rotational movement of the inlet ring 28 and cone 16 about an axial point on the longitudinal axis A. The dashed line illustrates the spherical shape of the curve of the movable outer surface 31 and of the movable interface 30. FIG. 8 illustrates a range of misalignment that can be corrected through the use of the movable interface 30. In FIG. 8 a range of 0-11 mm is shown as being corrected. However, it should be understood that a greater range may be correctable depending on the nature of the rotational movement and the degree of rotational movement permitted by the movable interface 30 and the a degree of axial movement permitted by the slot 17 and sealing ring 19.

The embodiments shown and disclosed in FIGS. 1-8 is able to accommodate misalignment between the inlet extension piece 15 and the cone 16. Furthermore, the loads that would typically bear down the IEP 18 are moved further upstream and accommodated by the movable interface 30 and the slot 17 and sealing ring 19. Additionally, one of the benefits of the arrangement described herein is that hardware installation does not need to occur inside the gas turbine engine 10 and blind assembly of the gas turbine engine can be avoided. This is due to the ability to securely fit the movable interface within the flow sleeve 20 without the need to further attach it with hardware.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed is:

1. A gas turbine engine comprising:
an inlet portion located at a combustor exit;
a cone connected to the inlet portion, wherein working gases from upstream flow downstream through the combustor exit and inlet portion to the cone;
an integrated exit piece connected to the cone, wherein working gases from the cone flow through the integrated exit piece;
an inlet ring forming a perimeter of the inlet portion surrounding the combustor exit, wherein the inlet ring has a plurality of struts extending radially,
a movable interface having a movable interface inner surface and a movable interface outer surface, wherein the movable interface surrounds the inlet ring and is connected to the plurality of struts, wherein the movable interface outer surface is curved; and
a flow sleeve surrounding the inlet ring having a sleeve inner surface and a sleeve outer surface; wherein the sleeve inner surface is curved and movably engages the movable interface outer surface.

2. The gas turbine engine of claim 1, wherein the inlet portion further comprises an inlet extension piece extending downstream from the inlet ring to the cone.

3. The gas turbine engine of claim 1, wherein the movable interface outer surface is spherically curved.

4. The gas turbine engine of claim 3, wherein the movable interface permits rotation of the movable interface in a range between 0.1° to 5.0° about a point located along a longitudinal axis, wherein the point is located at a center of the inlet ring.

5. The gas turbine engine of claim 3, wherein the sleeve inner surface is spherically curved.

6. The gas turbine engine of claim 1, wherein each of the plurality of struts are spaced equidistantly around the inlet ring.

7. The gas turbine engine of claim 1, further comprising a sealing ring, wherein the cone has a slot that extends circumferentially around an inner cone surface and the sealing ring extends within the slot.

8. The gas turbine engine of claim 7, wherein the slot permits movement of the sealing ring in an axial direction.

9. The gas turbine engine of claim 8, wherein a width of the slot is greater than a width of the sealing ring.

10. The gas turbine engine of claim 1, further comprising a sealing ring, wherein the integrated exit piece has a slot that extends circumferentially around an inner cone surface and the sealing ring extends within the slot.

11. A structure for rigidly connecting a cone to a combustor exit allowing movement between a flow sleeve and a cone in a gas turbine engine comprising:
an inlet ring forming a perimeter of an inlet portion surrounding the combustor exit the combustor exit, wherein the inlet ring has a plurality of struts extending radially,
a movable interface having a movable interface inner surface and a movable interface outer surface, wherein the movable interface surrounds the inlet ring and is connected to the plurality of struts, wherein the movable interface outer surface is curved; and
a flow sleeve surrounding the inlet ring having a sleeve inner surface and a sleeve outer surface; wherein the sleeve inner surface is curved and movably engages the movable interface outer surface allowing the cone to slide for angular alignment.

12. The structure of claim 11, wherein the movable interface outer surface is spherically curved.

13. The structure of claim 12, wherein the movable interface permits rotation of the movable interface in a range between 0.1° to 1.0° about a point located along a longitudinal axis, wherein the point is located at a center of the inlet ring.

14. The structure of claim 12, wherein the sleeve inner surface is spherically curved.

15. The structure of claim 11, wherein each of the plurality of struts are spaced equidistantly around the inlet ring.

16. The structure of claim 11, wherein the inlet ring, the struts and the movable interface are integrally formed as one piece.

17. A gas turbine engine comprising:
an inlet portion
a cone connected to the inlet portion, wherein working gases from upstream flow downstream through the inlet portion and combustor exit to the cone;
an integrated exit piece connected to the cone, wherein working gases from the cone flow through the integrated exit piece;
an inlet ring forming a perimeter of the inlet portion surrounding the combustor exit combustor exit, wherein the inlet ring has a plurality of struts extending radially,
a movable interface having a movable interface inner surface and a movable interface outer surface, wherein the movable interface surrounds the inlet ring and is connected to the plurality of struts, wherein the movable interface outer surface is spherically curved; and
a flow sleeve surrounding the inlet ring having a sleeve inner surface and a sleeve outer surface; wherein the sleeve inner surface is spherically curved and corresponds in size and shape to the movable interface outer surface, wherein the sleeve inner surface movably engages the movable interface outer surface to correct misalignment of the cone.

18. The gas turbine engine of claim 17, further comprising a sealing ring, wherein the cone has a slot that extends circumferentially around an inner cone surface and the sealing ring extends within the slot.

19. The gas turbine engine of claim 18, wherein the slot permits movement of the sealing ring in an axial direction.

20. The gas turbine engine of claim 19, wherein a width of the slot is greater than a width of the sealing ring.
